(19) United States
(12) Patent Application Publication
(10) Pub. No.: US 2012/0124389 A1
(43) Pub. Date: May 17, 2012

(54) Protecting images, and viewing environments for viewing protected images

(75) Inventors: Joanne Villani, Irvine, CA (US); Joshua Fialkoff, Schenctady, NY (US); Eric Heinz, New York, NY (US); Alexei Selivanov, Yekaterinburg (RU); Kozlov Sergey Aleksandrovich, Omsk (RU); Shalom Wertsberger, Barrington, RI (US)

(73) Assignee: PROTECTEDPIX, Las Vegas, NV (US)

(21) Appl. No.: 12/948,023

(22) Filed: Nov. 17, 2010

(51) Int. Cl. G06F 21/00; H04L 9/00; G06F 3/048

(52) U.S. Cl. 713/189; 726/26; 715/856

(57) ABSTRACT

A method, apparatus, and system are provided to facilitate protecting media such as images, documents, video streams, and the like, from unauthorized copying or distribution. The method is based on requiring certain conditions to be filled prior to, and during, display of the media on a user display. The conditions for display may require pointing device cursor placement, operating certain keys, and the like. Permissions are granted to users by the media owners and the permissions are checked prior to display. Thus the user is prevented from copying the media and using it illicitly, and the media owner may share media while at the same time maintaining control over the use thereof. The system may also be utilized to provide time-limited access to certain materials.

### FIELD OF THE INVENTION

The present application is directed generally towards protecting image data and more particularly towards protecting image data by requiring certain criteria be met and/or a user to take action before or when an image is displayed.

### BACKGROUND OF THE INVENTION

The Internet has changed the way that society operates, with largely beneficial results. Commerce, interpersonal communications, political activities and the like, are merged with entertainment, advertising and numerous other activities. Large numbers of social activities are Internet based, such as social networking, dating services, clubs and the like. However, participating in Internet, and/or other global network activities also has its perils: privacy is often breeched; maintaining one's identity is increasingly hard, and protecting copyrighted material becomes more difficult. Various efforts have been made to reduce those perils, especially in the area of protecting personal details like identity numbers, bank account numbers, credit card numbers, purchasing and web browsing patterns, and the like.

The problems common to maintaining privacy, preventing identity theft, and protecting copyrights, which are associated with images, are unique. Presently most social activities including networking sites such as Facebook® various dating services, and the like, are open for sharing images of oneself, and in practical terms almost force users to share their personal image so as to gain any advantage from such service. However sharing one's image has its perils as well: the image may be used by someone else pretending to be the person who posted the image, the image , edited and shared to show the person in a non-complimentary or compromising position, and the like. Even when certain images are exchanged between friends, the images may be forwarded to unintended viewers and/or otherwise abused if the friendship dissolves.

The problem of protecting the use of an image further extends to copyright issues. Copyrighted materials are sometimes shared in an unusable form. One example of such technique is to provide a very low resolution/small image of a photograph or a page from a book. People who would otherwise like to purchase such image do not do so, as they are unable to evaluate the full effect of such material from the low resolution image provided.

Those skilled in the art will recognize that the term ‘image’ is but one example of media and content which may benefit from the protection provided by the present invention. In some embodiments the protection extends to other content such as downloaded or streaming video, computer generated graphics or animations, pictures, drawings, scanned images, sketches, text, documents, and the like. It is noted that when displayed all such content becomes an image—whether static as an image or document or dynamically changing as in a video, animation, gaming and the like. Thus the present specifications will loosely utilize the terms ‘image’, ‘media’ and ‘content’ interchangeably to denote all content displayable on a computer, for which protection is desired. However, to increase clarity and brevity, many of the following examples will relate to ‘image’ by way of a particular example to the various forms of media mentioned above.

Thus there is a clear, but heretofore unfulfilled, need to allow a person who places media on a global network such as the Internet to control access thereto, and to prevent or at least place hardship on, unintended use of such media. The present invention is directed towards providing a solution to such need.

### SUMMARY OF THE INVENTION

Prior to abusing the media, it must be captured by the abuser. Common techniques to capture images are to download the media to local storage, screen capture, print or take a picture of a displayed image on a screen by using an external imaging device such as a camera.

An important aspect of the solution provided by the present invention involves requiring a user to engage in certain acts while viewing the image. Thus in one embodiment, an image may only be displayed when the mouse cursor is at a specified area on the screen. Other embodiments may require specific keys to be activated. Further aspects involve monitoring certain computer activities so as to prevent a screen capture from taking place when an image is displayed. Certain embodiments require controlling of certain keyboard keys or key combinations. By way of example, certain key combinations that will cause printing of the display content or dumping it into a file, need to be disabled. Thus in some embodiments the keyboard output is controlled and/or at least partially disabled.

To that end several embodiments are disclosed hereinafter, which include inter alia a method for protecting media from being copied, a client software for facilitating copying protection of such media, a portal for facilitating such protection, and a system which includes both the portal and at least one client computer, for allowing viewing of the image while it is being protected from copying.

Thus there is provided a method of protecting media from copying while being displayed on a display coupled to a computer, the computer being used by a current user and having at least one input device coupled thereto, the method comprising the steps of:
checking for existence of predetermined condition of the input device;
displaying the media on the display only as long as said predetermined condition is fulfilled; and,
disabling the media from the display when said predetermined condition is not fulfilled.

The term “Disabling” with all its inflictions, relating to image or to other types of media, should imply more than the mere complete or partial removal of the image from the display. This term should be construed to further extend to replacing an image with another image, partly obscuring an image or portions thereof, replacing the image with another, adding text or graphics to the image, blurring the image, or generally any action that will render the media quality sufficiently low as to make its copying and/or viewing of little interest, both to the copier/viewer and to the image owner. In addition to the above, when dynamic content is displayed, such as video, streamed video, animation, and the like, the image may become static, and all other disablement method mentioned above may be applied to either dynamic or static media.

Preferably, the media is formed of media data that is encrypted.

The input device may comprise a pointing device capable of pointing a cursor to different locations on display, in which case the predetermined condition comprises placement of said cursor at a predetermined area on the display. Alternatively, or in combination with, the input device may comprise a keyboard, in which case the predetermined condition may further comprise having at least one of the keyboard keys being activated. In case of a combination of keyboard and a second input device, a combination of both conditions is also considered.

In one embodiment which utilizes the keyboard, the predetermined condition further comprises activation of a plurality of keys, preferably selected so as to impede activation of said keys with a single hand.

In some embodiments, where the computer is coupled to a keyboard, the method further comprises monitoring activation of keyboard key or keys and allowing or denying activities from taking place by said computer, in response to such activation. Further, activation of certain keys or key combinations, whether simultaneous or subsequent, may cause disabling of the media.

The client computer may be constructed to concurrently execute a plurality of processes. In such environment one of the embodiments is further constructed to monitor the plurality of processes being executed, disabling the image from the display if it is already displayed, or avoiding displaying of the image if it is not already displayed, in accordance with the monitoring results. Thus, by way of example, the media will not be displayed in the first place, or will be removed from the display if already displayed, if a certain process is being executed, or if a process attempts certain actions that may circumvent the protection afforded by the present invention.

Preferably, the identity of the user is authenticated, and a check is performed if the user is authorized to view the image, prior to displaying the image. Preferably such authorization check is carried out prior to the display of each and every image, however a single authorization for a group of images is also contemplated.

In certain embodiments the image data is downloaded to the computer, and in certain embodiments the image data may be stored on the computer. If the image is downloaded it is preferred that the image data be encoded prior to downloading. However, if the image is stored on the computer used for viewing, such as on a non-volatile memory, the optional authentication and authorization is carried out by communicating with an authorizing authority outside the computer used for viewing the image. A preferred method to achieve that goal is to receive a decryption key from the authorizing authority. Typically the authorization authority will be a web based portal, however in certain embodiments such authorizing authority may be a manually operated authority such as a user to which the image belongs.

Generally, the steps of checking the condition of the input device or devices, displaying the image and disabling the image are preformed by a program being executed on the computer. According to the specific embodiment, the program may operate as a standalone program, it may be a web browser or be executed from within a web browser, it may be integrated into the operating system or into a device driver such as a display driver, or it may be integrated into an existing program such as image selection program, document viewer, and the like. The program may be downloaded to the computer and stored or cached thereupon, or it may be downloaded every time its use is desired. In certain embodiments this program may invoke other programs to display the image data.

In another aspect of the invention there is provided an image distribution portal for controlling copying of images in a global computer network. The portal comprises a storage having the image data stored therein, a data link coupled to the network, a user authenticator module, capable of querying and authenticating a portal user, and an image distributer module capable of retrieving image data and, if needed, the viewer program, from the memory, and sending the image data to a client program executed on a client computer coupled to the network. The client computer has a display and at least one input device coupled thereto. Preferably, the image data is sent encrypted. The client program is constructed to check for existence of predetermined condition of the input device, display the image on the display only as long as the predetermined condition is fulfilled; and remove the image from the display when the predetermined condition is not fulfilled.

It is noted that according to the invention, the plain image data is never saved to non-volatile memory on the client computer, such as a magnetic or optical disk, removable media such as flash ROM, and the like.

### SHORT DESCRIPTION OF DRAWINGS

The summary above, and the following detailed description will be better understood in view of the enclosed drawings which depict details of preferred embodiments. It should however be noted that the invention is not limited to the precise arrangement shown in the drawings and that the drawings are provided merely as examples.

FIG. 1 depicts a network environment in which the present invention may beneficially operate.

FIG. 2 depicts an example of a display, keyboard, and mouse which may be utilized with the present invention, and further displayed a blanked image, and a user prompt.

FIG. 3 depicts a simplified flow diagram of an aspect of the present invention.

FIG. 4 depicts the displayed image once conditions for display are fulfilled.

FIG. 5 depicts optional actions to be taken by a viewer program.

FIG. 6 depicts example instructions a user must fulfill in order to display an image.

FIG. 7 depicts a simplified handshake and initialization of a web/applet based image viewer according to an embodiment of the invention.

FIG. 8 depicts simplified initialization steps of yet another embodiment of the invention.

FIG. 9 depicts a simplified schematic block diagram of an optional web portal.

### DETAILED DESCRIPTION

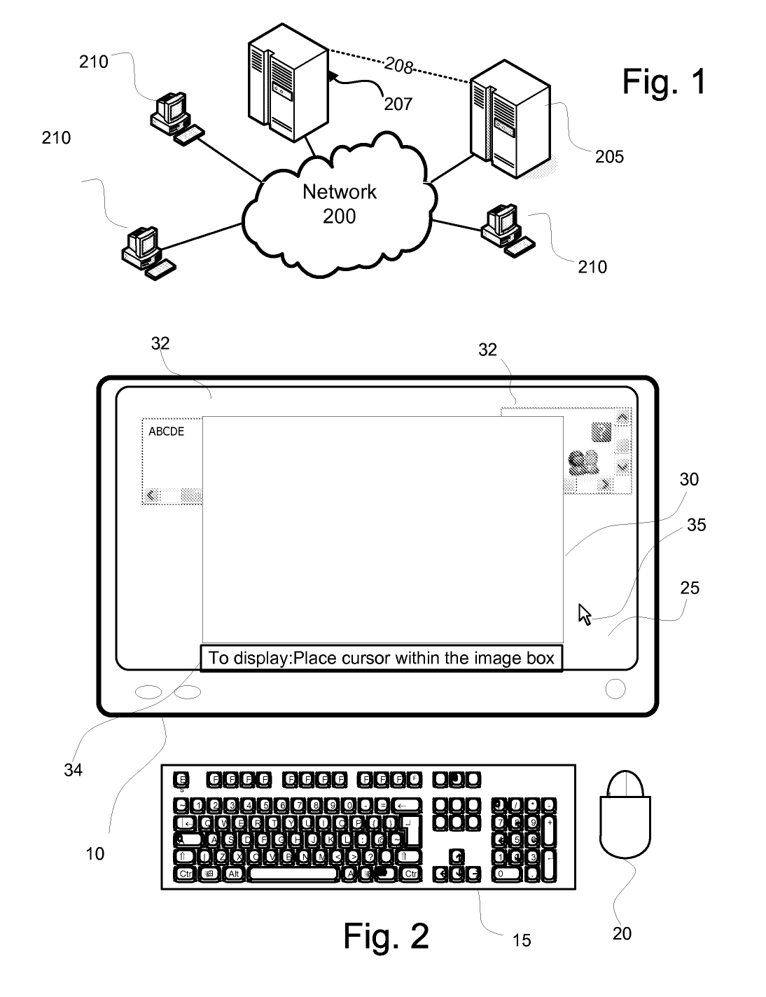

FIG. 1 depicts a simple network system in which several embodiments of the invention may operate. Server 205 may be a web server, for example embodying a web portal for protected images, an authentication server, an identification server, an encryption key provider, or any combination thereof. It is noted that the server may comprise a single computer or a plurality of computers that may or not reside in the same place. Server 205 is coupled directly or indirectly to a global communication network 200 such as the Internet, an intranet, and the like. Client computers 210 are also coupled to the network 200. The term client computers extends to any device capable of receiving and displaying images in response to a user input, such as personal computers and other servers, televisions capable of communicating over the network and selectively retrieving images therefrom, cable or telephony set-top boxes, personal digital assistants, computerized readers such as Apple© I-pad, Amazon© kindle, and the like.

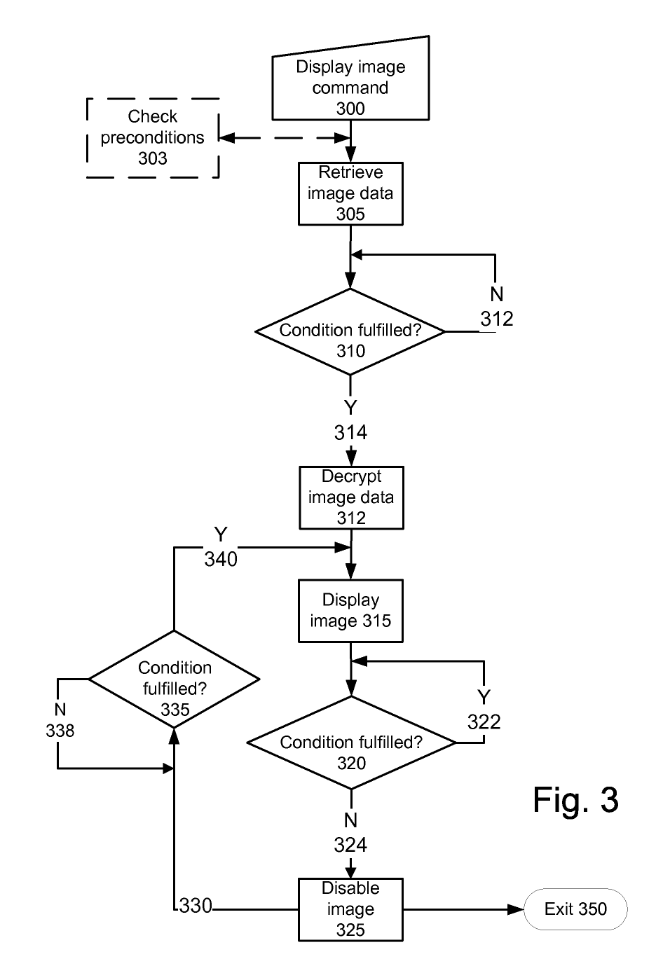

FIG. 2 depicts a simplified example of various devices for some embodiments of the present invention. Clearly a display 10 is needed to display the image, and the display may be embedded within any of the client computers, or otherwise coupled thereto. The display area shows a number of windows 32, an empty area 25, and the image display window 30. The computer selected for this example has a mouse which serves as a pointing device 20, and a keyboard 15. The operation of a basic embodiment will be described below, in conjunction with FIG. 3, which depicts a simplified flow diagram of the basic process. It is noted that the display, as well as one or more pointing devices, and other input devices such as keyboards, may be embodied within the client computers, as is the case in laptop computers, or may be discrete units as is common with desktop computers, remote control units, and the like.

In a basic embodiment of the invention, the user provides an initial command 300 instructing the client computer to display the media. The client computer then retrieves the media data 305. The client computer may obtain the media data from local memory such as a hard disk, a flash drive, an optical disk, and the like. However in the preferred embodiment the media data is obtained via the network 200, such as the case when the system utilizes the portal in server 205 as the media data source. It is clearly desired that the media data will be encrypted so as to prevent interception of the media data.

The following will assume that the media is an image, but the skilled in the art will recognize the applicability to any type of media, and understand that the description thus applies to all media.

Prior to displaying the image, the client computer checks to see if a certain condition is fulfilled 310. The condition may be built into the system software or may be dictated by the image. Thus for example the condition may be that the cursor 35 must be placed within a pre-determined of the display 10. In order to assist the user, a prompt 34 may be provided, which would specify the condition required for displaying the image. As seen in FIG. 2, the cursor 35 is placed on an empty portion of the screen 25, but it may also reside in one of the windows 32 which are used by other programs. However, in this specific example, the condition is not met until the cursor outside image display window 30.

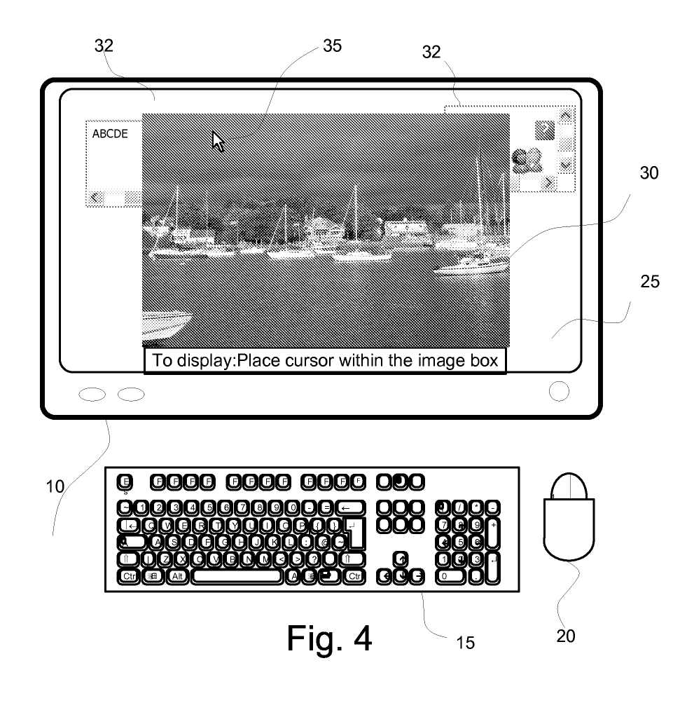

The client computer will continue to check the condition 310 as long as the condition is not fulfilled 312. When the user uses the keyboard 15 or the pointing device 20 to place the cursor 35 in the image display window 30 (as may be seen in FIG. 4), the condition is fulfilled 314, the image data is decrypted 312 if needed, and the image is displayed 315. The requirement of placing the cursor 35 in a specific area of the display is termed “Cursor Restriction” hereinafter.

The client computer continues to monitor the condition 320. As long as the condition is fulfilled 322, the image is displayed. However if the condition is not satisfied 324, the client computer disables the image 325 from the display 10. In certain embodiments, the execution path will follow arrow 330, and the condition will again be monitored 335. The media will stay disabled as long as the condition is not fulfilled 338 and re-displayed, if the condition is fulfilled 340. In other embodiments the sequence of operations will terminate 350, and displaying the image again will require re-activation.

As indicated by the dashed box 303, certain pre-conditions may apply.

Commonly, the client computer will need to verify permissions for display. Thus by way of non-limiting example, the user identity is first authenticated, and a check is conducted if the user is authorized to view the image.

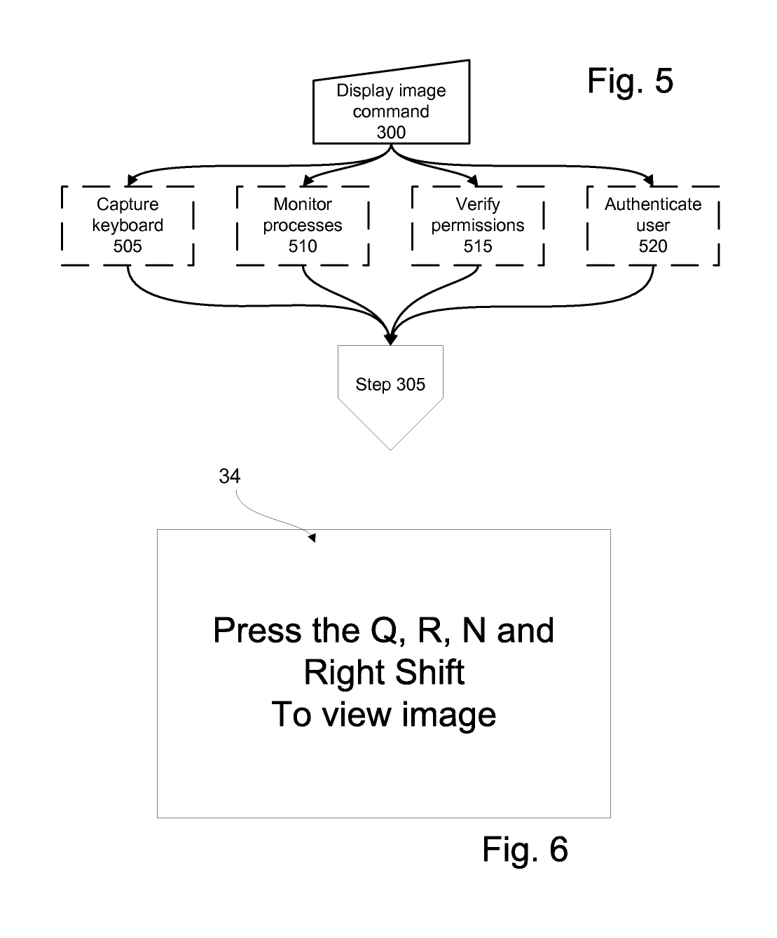

Additional actions are preferably taken by the client computer, some of which are depicted schematically in FIG. 5. Thus, by way of example, the client computer keyboard activity may be captured during displaying of the image 505. Capturing keyboard activity allows control of key presses when the image is displayed, and thus prevents the user from activating a program which may capture the displayed media, either in a computer readable, or human readable form. Yet another optional action is monitoring other processes 510 being executed on the computer, and avoiding the display of an image, or disabling the image if already displayed, if certain processes are being executed at the same time that the image is to be displayed. Authenticating the user 520 may be carried out by any convenient means such as password identification, hardware matching, thumbprint identification, and the like. Verifying permission 515 of the authenticated user to view the image offers continual control of the image owner as to who may view the image. It is noted that while the example provided in FIG. 5 places those activities between the command to display the image 300 and the retrieval of the image data 305, the skilled in the art will know that those actions may be started at any time, and may continue to run as long as desired.

The conditions to be fulfilled for displaying the media 310, 320, 335, and the like are not limited to Cursor Restriction, and may include a variety of other condition, taken singly or in any desired combination. In one embodiment the user is required to activate certain keyboard keys so that the condition of steps 310 and 320 are fulfilled. Preferably the key selection is selected so as to impede activation of the keys with one hand. FIG. 6 depicts an example of a prompt window 34, prompting the user to activate a key combination that will require most users to use two hands to activate on a standard QWERTY keyboard. A key combination which impedes activation by one hand is any key combination that would present hardship to the user to activate with one hand carries the advantage of keeping the user hands busy and in known configuration, thus making it more difficult for the user to activate an illicit software, use a camera to grab he image, and the like. The requirement supra for key activation is termed “Keyboard Restriction” hereinafter.

By way of illustrating one preferred embodiment, the example of an internet website will be considered. The website provides image owners the opportunity to store their images, and to designate access rights to the images by other users. Users access content from a web browser, a dedicated viewer, a downloadable applet, and the like. The provided example will utilize an applet, such as an applet implemented on the client computer 210 within a container provided by a web browser. The viewer Applet may be implemented by any desired technology, such as Java, JavaScript, AppleScript, Adobe Flash, and the like. Certain extensions of the applet may be required to implement selected optional features, such as process monitoring, keyboard capture, and the like. This may be accomplished by Windows extensions, OSX extensions, and the like.

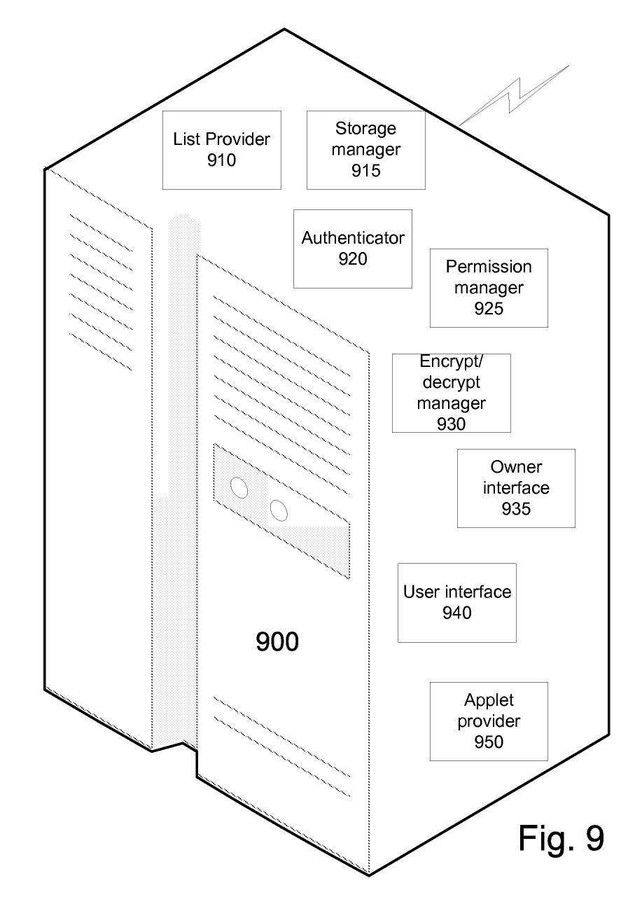

It is noted that the viewer applet communicates with a cooperating server being executed on the server 205. The server may be implemented utilizing any desired technology such as Apache, Django, PHP, a native language like C or C++, and the like. The selection of technology and environment for providing both the applet and the cooperating server is a matter of technical choice. FIG. 9 depicts a simplified block diagram of a portal, or web server 900 containing a list provider 910, a storage manager 915, an authenticator 920, a permission manager 925, encryption/decryption manager 930, an owner's interface 935, a user interface 940, and an applet provider 950. The list provider 910 provides lists of images available for viewing. The storage manager 915 is responsible for storing images, retrieving the images, and sending them to the client computer. The authenticator 920 is tasked with authenticating a user identity. Permission manager 925 verifies that a certain user has authority to view specific images. The encryption/decryption manager 930 provides keys for decryption to the client computer, and optionally encrypt the images. In certain embodiments the images are encrypted prior to being stored in the server storage, and in others the encryption takes place prior to transmitting the image to the client computer. Encryption/Decryption manager 930 manages the encryption in such embodiments, and optionally in embodiments where the images are stored encrypted as well. The owner's interface 935 facilitates loading and unloading of images, setting image viewing permissions for specific users or user groups, and the like. The user interface 940 handles interfacing with the users of the client computers, and facilitates activities such as authentication, providing web pages for viewing the picture, session management, and the like. The applet provider 950 is the portion responsible for providing the viewer to those users that wish to download it, and in certain embodiment associate the applet with a session, provide applet identification, and the like. It will be seen that the example web server provided supra is but one of many possible embodiments that will be clear to the skilled in the art, and that the division of functionality described is arbitrary and provided by way of non-limiting example. The skilled in the art will recognize that the portal may be embodied by a single or a plurality of computers.

Preferably, every instance of the Applet is uniquely identifiable so as to allow the user to load multiple instances of the Applet in multiple windows. Opening a webpage with an embedded viewer initiates the following series of steps:
The user requests webpage 705 from web server 900.
The server 900 generates a unique Applet ID 710.
The server further registers the applet and allocates and associates storage for the applet instance according to its ID, creates a user session, and links the applet instance with the user session 715.
The server provides the client with a web page which activates the applet. The applet may be downloaded from the server or cached at any convenient arrangement.
The browser requests 720 the Applet from the Server in response to the embed code, and the server returns the applet 725, and the browser loads and executes the applet 730. It is noted that further communication between the Applet and the Server include the Applet's ID.
The browser and the server perform handshake procedure 735, in which keys are generated and exchanged, to establish encryption. The selection of the handshake and encryption is a matter of technical choice, and will be clear to the skilled in the art. The handshake procedure 735 allows the server and the applet to communicate securely utilizing encryption, HTTPS, and the like.

Once initialization is achieved and the secure link is established between the applet and the server, the applet retrieves information about images available from the server by requesting 740 a list of images from the list provider 910 in the server. This step is embodiment specific but requesting 740 and retrieving 745 list of the images will be clear to the skilled in the art. Preferably, the image list includes information about images, such as size, caption, and the like. Preferably the image list information may further contain the desired condition that must be fulfilled (steps 310, 320) for displaying the image, By way of example, the conditions may include “Cursor Restriction”, “Blur and Keyboard Restriction” which requires the users to activate certain keys on a keyboard or like device, or any combination of conditions. The example of “Blur” is notable as yet another example to the flexibility offered by the present invention, which allows setting various conditions and various actions to be associated with the display of images. Thus, in the case of the blur instruction, the image is not completely removed if the condition required by 310 and 320 (keys in this instance), but is instead blurred sufficiently as to prevent it usability if copied. Other common conditions may include “Cursor Restriction and Keyboard Restriction”, “Multiple Keys”, “Mouse and Multiple Keys”, “Mouse, Inactive Keyboard, Process Monitoring”, and the like. The skilled in the art will recognize that such combinations may easily be encoded in a small number of bits.

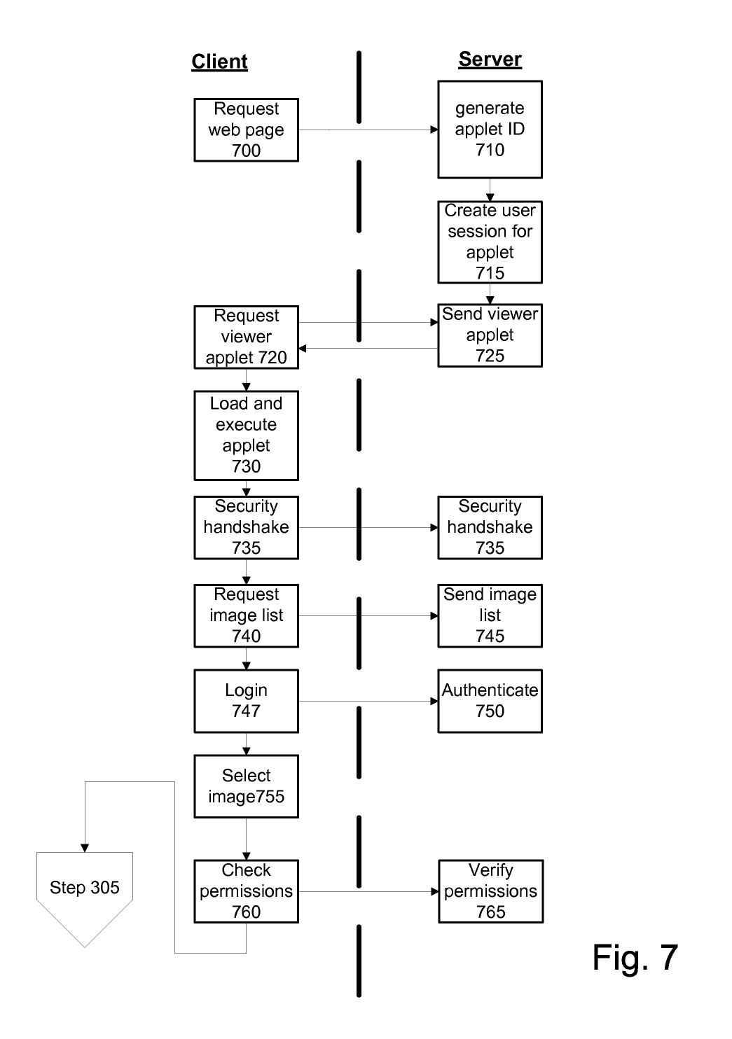

While the drawing presents the authentication procedure 520 (as implemented by login 747 and authenticate 750 in the example depicted in FIG. 7), as occurring at this stage, the skilled in the art will readily understand that the authentication process may take place earlier or later as desired. This is similar to many other steps and procedures, the order of which is a matter of technical choice. By way of example repeat authentication may be required prior to displaying each image in a sequence, renewal of the authentication is required after a certain amount of elapsed time, and the like.

After authentication, the user selects an image from the image list 755. The applet checks if the user have permission 760 to view the picture, and once the server verifies the permission 765 for the specific user to view the image, the program continues to step 305—retrieving the image data, as described for FIG. 3. It is noted that checking permission for viewing the media may be performed at other locations in the flow that the specific location described above and/or that viewing permissions may be repeatedly checked. By way of example, in the preferred embodiment, permissions for viewing the image are checked during Request image list 740. The method of authentication and permission checks are a matter of technical choice and various solutions will be clear to the skilled in the art.

An optional aspect offers integration of a separate media protection service into a service provided by another vendor. This may be desired for offering integration between several service providers, without burdening the user with dealing with several interfaces, multiple authentications, and the like. By way of example, after a secured media portal establishes its credentials, it will allow another web site to offer the media owner the security of the well established service, while maintaining the user interface, authentication, and the like, of the host web site. FIG. 2 depicts a second server 207 coupled to the global network 200. In the example provided herein , the second server 207 is a web server, but may be a corporate server, a special purpose server, and the like. Communications between the media server 205 and the web server 207 may be carried out over the global network, or over an optional specialized data link 208. The skilled in the art will recognize that specialized data links may be implemented as secured communications over the network 200 or by a separate hardware communication link separate therefrom.

When a user requests content from the web server 207 it provides content to a user. If the user requests protected media from the web server, the web server is capable of providing such media. An example of a process which allows such capability is described below, but the skilled in the art will recognize that the example is but one way of achieving such capability.

The web server 207 may authenticate the user, check permissions, and the like, or be a conduit for such authentication and permission checks by the media distribution server 205. Preferably, the web server 207 will at least authenticate the user. Permission check may be handled by the web server 207 either against a local permission database or check for permission against a database handled by the protected media server 205. Once the identity and permission has been established, the web server 207, utilizing a secure connection with the media server 205, requests an access token for the specific media from the media server 205. The server then sends a page containing the token and optionally other information such as a link to the media server 205, a viewer applet or a link thereto, instructions, and the like, to the client computer. The client computer communicates the token to the media server, and after checking certain conditions (such as validity of the token, existence of the desired media, and the like) the media server returns the required media to a viewer program operable to display the media only under the conditions, as described above.

Clearly the whole functionality provided above may be handled a single server, which incorporates the secured media functionality, as well as the added functionality specific to the web server primary service. Similarly, division between different functions will also be clear to the skilled in the art. Thus, by way of example different servers may be used for authentication, storage management, user interface, and the like.

The applet, or any other software implementing different aspects of the invention, may initiate necessary actions for security, such as keyboard capture, process monitoring, and the like. In certain embodiments those actions will be activated by default, and in other embodiments such actions may be dictated by information coupled to the image and/or included in the image list data.

Keyboard capture 505 implies that the keyboard 15 is rendered practically inoperative for all process but for the processes under control of the viewer application. Preferably, the user of a client computer will experience the same results as if the keyboard was disconnected from the computer, except perhaps if certain key combinations unique to the operating system (such as the combination <Control-Alt-Delete> in the Microsoft Windows© operating system) . Commonly, such action also requires that the input focus stay in the application, which implies that the pointing device will not be activated outside the viewer related window, however keyboard capture may be implemented regardless of the cursor position, pointing device actions, and the like. Different techniques, programs, or processes may be utilized to render the keyboard inoperative for selected operations, and specific embodiments will depend on the operating system in which the viewer operates, and will be clear to the skilled in the art. By way of example, in the example discussed hereinabove, the keyboard capture function 505 may be accomplished utilizing a web extension application.

Process monitoring 510 implies monitoring other processes which may be active on the client computer, and not displaying the image, or disabling it from the display, if certain processes are operating concurrently. The specific processes are such processes that are deemed directed and/or able, to defeat the protection provided by the viewer. In certain embodiments a list of suspected processes may be downloaded or encoded into the viewer program. In other embodiments, certain activities may trigger the assumption that the image should not display. Such actions include, inter alia, attempts to access the video memory, attempts to utilize the screen display interrupt (if supported by the operating system), and the like.

The implementation of ensuring that the Cursor Restriction conditions are fulfilled will also depend on the specific operating environment, and will be clear to the skilled in the art. The most common pointing devices are mice and touch pads, but other devices such as joysticks, switches, tablets, and the like are explicitly contemplated. Most of those devices include keys that may be activated in combination with, or separately from, the pointing action. In a simple embodiment, the cursor 35 which is controlled by the mouse or touch tablet, is required to stay within the confines of the image display window or the web browser. However certain embodiments may demand another placement, such as creating a second window in which the cursor must lay, but where it does not interfere with viewing of the image.

As discussed above, another image may be used as a placeholder or a link to the media being protected either before it is displayed or a part of the disablement.

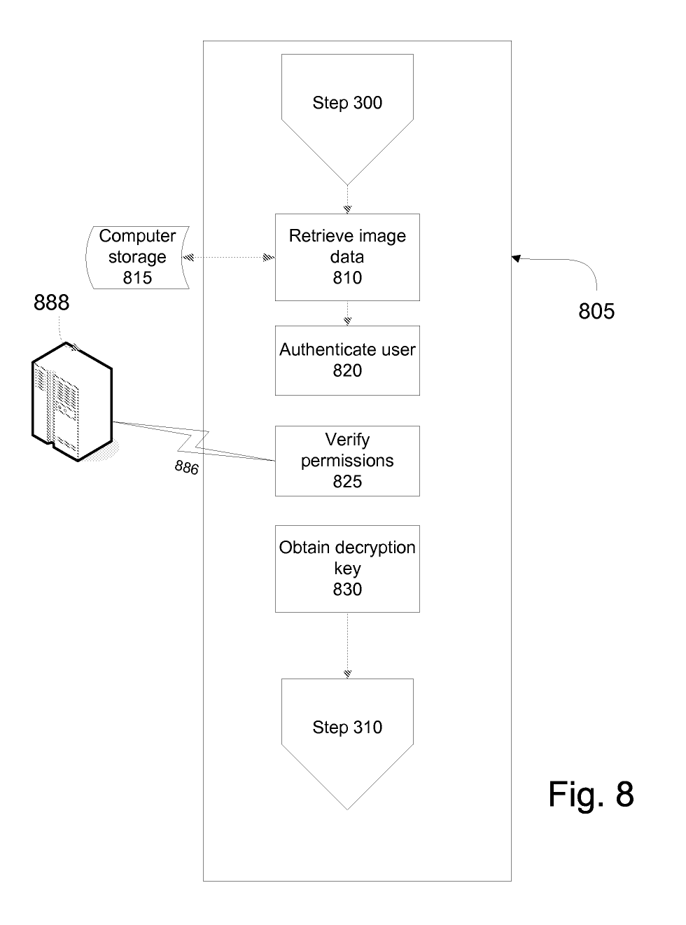

FIG. 8 represents yet another embodiment of the present invention, usable for controlling usage of images that reside on the user computer or attached storage. A program 805 is executed on the client computer. The program may be a standalone program such as a viewer, portion of computer code embedded in the operating system or loaded thereto, and the like. When the user initiates a “display Image” command as depicted in step 300, the image is retrieved 810 from the attached storage. The attached storage may be any computer readable storage to which the computer has access at the required time. The stored image should be encrypted in order to prevent unauthorized copying. The program authenticates 820 the user identity by any convenient manner, and communicates with server 888 via communication link 886, to verify 825 that the user have the necessary permissions to view the image. If the user has permission to view the image, a decryption key is obtained from the server 830 and the program execution continues to step 310 of FIG. 3. It is noted that the authentication stage may also be carried out in communication with the server 888 (not shown).

In the preferred embodiments, the image owners have the right to set viewing permissions for their images. Preferably, the image owner may set permissions for individual users and for individual images. Permissions may further set to include varying level of security. Thus, by way of example, an image owner wishing to utilize a web based service as described above, may subscribe to a certain service level which will provide only Cursor Restriction, to a service level which will also provide the Keyboard Restriction, either by one hand or two, or add other conditions as described above.

For brevity these specifications utilize the Internet as the network environment in which the present invention operates. However, the skilled in the art will readily recognize the applicability to other environments, such as intranet, multi-user computer systems, and the like.

In case of large media, such as large images, documents and other materials containing more content than can fit on the display at one time, there is a need for navigating within the content. In temporal based content such as video, selecting a location within the stream is also desired. To that end, scrolling, panning, zooming, and the like may be provided by the pointing device. Alternatively keyboard activity may be limited to certain keys only. By way of example, instead of allowing only the keys Q, R, N, and <Right Shift> as depicted in FIG. 6, the keys representing W, T, B, and </> may also be allowed to represent right and left and up and down movement.

The terms computer and computer display, should be construed to encompass web enabled television displays such as televisions coupled to the Internet either through an adapter device, or having network interface build therein, personal digital assistance device, cellular terminal, laptop computers, and the like. The term non-volatile memory should be construed to extend to any and all computer storage which is capable of maintaining its information while the computer power is removed. While a mouse is used by way of example as a common embodiment of a pointing device, the term mouse is used as a generic name for all pointing devices, such as a trackball, a touchpad or tablet, an optical pointer, acceleration based devices, and the like. Similarly the term keyboard should be construed to extend to any key or temporary switch based device, including by way of non-limiting example touch screens, and others that cause a signal to be sent to the computer when activated by a user.

The environments in which embodiments of the present invention may operate extend beyond the specific embodiments described herein by way of example. Thus the invention may operate not only as an applet program operating at least partially from within a web browser, it may also be incorporated within a program such as a dedicated program, incorporated as an integral portion of a web browser, integrated into a computer operating system, either as a library or a basic portion thereof, and the like. The terms associated with actions of the client computer are taken by the appropriate software, as will be clear to the skilled in the art. Dedicated programs,or even web based programs may provide a platform capable of calling other programs and provide the conditions for viewing the image from within such programs. Thus by example, an applet based viewer may call and activate an Adobe Acrobat© program and keep such program operative only as long as the conditions for display 310, 320, and 335 are fulfilled.

It will be appreciated that the invention is not limited to what has been described hereinabove merely by way of example. While there have been described what are at present considered to be the preferred embodiments of this invention, it will be obvious to those skilled in the art that various other embodiments, changes, and modifications may be made therein without departing from the spirit or scope of this invention and that it is, therefore, aimed to cover all such changes and modifications as fall within the true spirit and scope of the invention, for which letters patent is applied.

I claim:

1. A method of protecting media from copying while being displayed on a display coupled to a client computer, the computer being used by a current user and having at least one input device coupled thereto, the method comprising the steps of:
checking for existence of predetermined condition of said input device;
displaying said media on said display only as long as said predetermined condition is fulfilled; and,
disabling said media from said display when said predetermined condition is not fulfilled.

2. A method as claimed in claim 1, wherein said at least one input device comprises a pointing device capable of pointing a cursor to different locations on said display, and wherein said predetermined condition comprises placement of said cursor at a predetermined area on the display.

3. A method as claimed in claim 1, wherein said at least one input device comprises a keyboard, and wherein said predetermined condition comprises having at least one of the keyboard keys being activated.

4. A method as claimed in claim 3, wherein said predetermined condition further comprises activation of a plurality of keys, and wherein said plurality of keys is selected so as to impede activation of said keys with a single hand.

5. A method as claimed in claim 3, wherein said computer is further coupled to a pointing device capable of pointing a cursor to different locations on said display, and wherein said predetermined condition further comprises of placement of said cursor at a predetermined area on said display.

6. A method as claimed in claim 1, wherein said computer is coupled to a keyboard, the method further comprising monitoring activation of a key or keys on said keyboard, and allowing or denying activities from taking place by said computer, in response to said activation.

7. A method as claimed in claim 1, wherein said computer is coupled to a keyboard, the method further comprising monitoring activation of a key or keys on said keyboard, and disabling said media from said display responsive to activation of selected key or keys.

8. A method as claimed in claim 1, wherein the media is formed of media data that is encrypted.

9. A method as claimed in claim 1, wherein said computer is constructed to concurrently execute a plurality of processes, further comprising the steps of:
monitoring said plurality of processes being executed on said computer, and producing monitoring results; and,
disabling said media if it is already displayed, or avoiding displaying of said media if it is not already displayed, in accordance with said monitoring results.

10. A method as claimed in claim 1, further comprising the step of checking if said user is authorized to view the media prior to said step of displaying the media.

11. A method as claimed in claim 1, wherein said media is formed of media data being sent to said computer via a data link.

12. A method as claimed in claim 11, wherein said media data is encrypted.

13. A method as claimed in claim 12, further comprising the steps of authenticating the identity of said user, and verifying that said user is authorized to view said media, prior to said step of displaying.

14. A method as claimed in claim 1, wherein said media comprises encrypted media data stored on a non-volatile memory device coupled to said computer, the method further comprises the steps of:
Communicating an identity of said user to an authorizing authority outside of said computer; and,
Verifying that said user is authorized to view said media prior to said step of displaying.

15. A method as claimed in claim 14, further comprising the step of receiving a decryption key from said authorizing authority.

16. A method as claimed in claim 1, wherein said steps of checking, displaying and disabling are preformed by a program being executed on said computer.

17. A method as claimed in claim 16, further comprising the step of invoking a second program to display said media.

18. A method as claimed in claim 16, wherein said program is a web browser._{—}

19. A method as claimed in claim 16, wherein said program is downloaded to said computer.

20. A method as claimed in claim 16, wherein said program comprises a portion of an operating system controlling at least selected aspects of the operation of said computer.

21. A method as claimed in claim 16, wherein said program is embedded within a device driver operable on said computer.

22. A method as claimed in claim 22, wherein said device driver is display driver.

23. A system for protecting media from copying while being displayed on a display coupled to a client computer, the computer the system comprising:
a online media distribution portal coupled to a memory, and to a first communication link, said media being stored in said memory;
a client computer coupled to a display, a second communication link capable of communicating with said first communication link, and at least one input device;
said client computer having software configured to :
receiving media data from said portal via said second communication link;
checking for existence of predetermined condition of said input device;
displaying said media on said display only as long as said predetermined condition is fulfilled; and,
disabling said media from said display when said predetermined condition is not fulfilled.

24. A system as claimed in claim 24, wherein said software is downloaded to said computer via said communication link.

25. An online media distribution portal for controlling copying of said media in a global computer network the portal comprising:
storage having media data stored therein;
data link coupled to said network;
a user authenticator module, capable of querying and authenticating a portal user;
an media distributer module capable of retrieving media data and said viewer program from said memory and sending said media data to a client program executed on a client computer coupled to said network, the client computer having a display and at least one input device coupled thereto;
wherein said media data is sent encrypted; and,
wherein said client program is constructed to:
check for existence of predetermined condition of said input device;
display said media on said display only as long as said predetermined condition is fulfilled; and,
remove said media from said display when said predetermined condition is not fulfilled.

26. An online portal as claimed in claim 26, wherein the client program is downloaded from said portal prior to displaying said media.
